(19) United States
(12) Patent Application Publication
(10) Pub. No.: US 2020/0309811 A1
(43) Pub. Date: Oct. 1, 2020

(54) CHARGE OUTPUT DEVICE, ASSEMBLY METHOD THEREOF AND PIEZOELECTRIC ACCELERATION SENSOR

(71) Applicant: FATRI (Xiamen) Technologies Co., Ltd., Xiamen City (CN)

(72) Inventors: Yongzhong NIE, Xiamen City (CN); Chuan Nie, Xiamen City (CN); Ying Gao, Xiamen City (CN)

(73) Assignee: FATRI (Xiamen) Technologies Co., Ltd., Xiamen City (CN)

(21) Appl. No.: 16/533,860

(22) Filed: Aug. 7, 2019

(30) Foreign Application Priority Data
Mar. 26, 2019 (CN) 201910233028.2

(51) Int. Cl. G01P 15/09

(52) U.S. Cl. CPC G01P 15/09; G01P 15/0915

(57) ABSTRACT

The present disclosure relates to a charge output device, an assembly method thereof, and a piezoelectric acceleration sensor, the charge output device comprises a bracket comprising a support member and a connecting member disposed on the support member; a piezoelectric element surrounding the connecting member and comprising a plurality of piezoelectric crystal groups and electrode plates, the plurality of the piezoelectric crystal groups are disposed at intervals in a circumferential direction of the connecting member and surrounds the connecting member in a polygonal arrangement, the piezoelectric crystal group comprises at least one piezoelectric crystal, the at least one piezoelectric crystal and the electrode plates are alternately stacked in a normal direction of a circumferential surface of the connecting member; and a mass surrounding an outer surface of the piezoelectric element and suspended above the support member, the connecting member, the piezoelectric element and the mass are interference-fitted with each other.

### CROSS REFERENCE TO RELATED APPLICATION

This application claims priority to Chinese Patent Application No. 201910233028.2, filed on Mar. 26, 2019, which is hereby incorporated by reference in its entirety.

### TECHNICAL FIELD

The present disclosure relates to a technical filed of sensor technologies, and particularly relates to a charge output device, an assembly method thereof and a piezoelectric acceleration sensor.

### BACKGROUND

A piezoelectric acceleration sensor, also known as a piezoelectric accelerometer, is an inertial sensor. The principle of the piezoelectric acceleration sensor lies in the piezoelectric effect of the piezoelectric element. When the accelerometer is vibrated, a force applied on a piezoelectric element by a mass changes. When a vibration frequency under measurement is much lower than a natural frequency of the accelerometer, the change in force is proportional to an acceleration under detection.

As the requirements on accuracy for acceleration detection become higher and higher, the requirements on sensitivity of piezoelectric acceleration sensors is getting higher and higher. For example, standard piezoelectric acceleration sensors are used to calibrate acceleration sensors. Therefore, the requirements on performance of the standard piezoelectric acceleration sensors are higher and higher sensitivity is required. However, existing piezoelectric acceleration sensors are generally not sensitive enough, and cannot meet the requirements of standard piezoelectric acceleration sensors.

Therefore, there is a need for a charge output device with higher sensitivity to meet the requirements of the standard piezoelectric acceleration sensors.

### SUMMARY

Embodiments of the present disclosure provide a charge output device, an assembly method thereof, and a piezoelectric acceleration sensor, which can improve sensitivity of the charge output device, improve rigidity of the entire piezoelectric element, and reduce stress fluctuations in respective materials caused by temperature, thereby ensuring measurement accuracy.

Directed to the above technical problems, the embodiments of the present disclosure provide a charge output device, comprising: a bracket, comprising a support member and a connecting member disposed on the support member; a piezoelectric element, configured to surround the connecting member, the piezoelectric element comprises a plurality of piezoelectric crystal groups and electrode plates, wherein the plurality of the piezoelectric crystal groups are disposed at intervals in a circumferential direction of the connecting member and are configured to surround the connecting member in a polygonal arrangement, the piezoelectric crystal group comprises at least one piezoelectric crystal, and the at least one piezoelectric crystal and the electrode plates are alternately stacked in a normal direction of a circumferential surface of the connecting member; and a mass, configured to surround an outer surface of the piezoelectric element and suspended above the support member, wherein the connecting member, the piezoelectric element and the mass are interference-fitted with each other, and the respective piezoelectric crystals are connected in parallel via the electrode plates and the mass.

According to an aspect of the present disclosure, the electrode plates comprise a plurality of first electrode plates and at least one second electrode plate, one of positive electrodes and negative electrodes of the respective piezoelectric crystals are connected via the first electrode plates and the mass, and the other one of the positive electrodes and the negative electrodes of the respective piezoelectric crystals are connected via the at least one second electrode plate; and wherein two surfaces of two adjacent piezoelectric crystals in the piezoelectric crystal group, close to each other, have the same polarity.

According to an aspect of the present disclosure, the piezoelectric crystal group comprises a plurality of piezoelectric crystals, and the first electrode plate comprises a first stacking portion and a first connecting portion, the first stacking portion is disposed between two adjacent piezoelectric crystals in the piezoelectric crystal group; and the second electrode plate comprises a second stacking portion and a second connecting portion, the second stacking portion is disposed between two adjacent piezoelectric crystals in the piezoelectric crystal group, the first stacking portion and the second stacking portion are alternately disposed, the first connecting portion is connected with the first stacking portion, and the second connecting portion is connected with the second stacking portion; the first stacking portion has a size greater than or equal to that of the piezoelectric crystal, such that the piezoelectric crystal is entirely attached to the first electrode plate; and/or the second stacking portion has a size greater than or equal to that of the piezoelectric crystal, such that the piezoelectric crystal is entirely attached to the second electrode plate.

According to an aspect of the present disclosure, the first electrode plate comprises a plurality of the first stacking portions and at least one first connecting portion, the first stacking portion is further disposed between the piezoelectric crystal of an outermost layer and the mass, and the first connecting portion is configured to connect two or more of the first stacking portions in the piezoelectric crystal group; and/or, the second electrode plate comprises a plurality of the second stacking portions and a plurality of the second connecting portions, the second electrode plate is disposed to surround the piezoelectric element in a circumferential direction of the piezoelectric element, the respective second stacking portions of the same layer in the respective piezoelectric crystal groups are connected by the second connecting portions to form a broken annular structure in the circumferential direction, and two adjacent annular structures are connected by the second connecting portion.

According to an aspect of the present disclosure, the support member comprises a mounting hole extending in an axial direction of the support member; the connecting member includes a connecting part and a pre-tensioning assembly, the connecting part is able to extend into the mounting hole to be connected with the bracket, and the pre-tensioning assembly is configured to surround the connecting part and has a plurality of connecting faces distributed in a circumferential direction of the pre-tensioning assembly; and the plurality of the piezoelectric crystal groups are respectively disposed on different connecting faces.

According to an aspect of the present disclosure, the connecting part comprises a support portion and a mounting portion, the mounting portion is connectable with the support member, and the support portion is formed in a tapered shape and has an average radius gradually decreasing in a direction approaching the support member.

According to an aspect of the present disclosure, the connecting part is a tapered self-locking bolt.

According to an aspect of the present disclosure, the pre-tensioning assembly comprises a plurality of pre-tensioning parts, and the plurality of pre-tensioning parts are disposed at intervals in the circumferential direction of the connecting part; and the pre-tensioning assembly is provided with a tapered through hole extending through the entire pre-tensioning assembly in a thickness direction, the connecting part is inserted into the tapered through hole, and an average radius of the tapered through hole gradually decreases in a direction approaching the support member.

According to a further aspect of the present disclosure, it is provided an assembly method of the charge output device, the method comprises steps of: disposing an external clamping device to correspond to the support member of the bracket; installing the piezoelectric element in a circumferential direction of the external clamping device, such that the piezoelectric element is configured to surround the external clamping device in a polygonal arrangement; providing the mass on an outer peripheral side of the piezoelectric element; inserting the connecting member inside the piezoelectric element, moving the connecting member toward and connecting it to the support member, wherein the piezoelectric element is interference-fitted with the mass by the connecting member; and taking the external clamping device out of the charge output device.

According to a further aspect of the present disclosure, it is provided a piezoelectric acceleration sensor, comprising: the charge output device as described above; a casing having an accommodation space, wherein the charge output device is disposed in the accommodation space; and a signal output portion disposed on the casing.

In the embodiment of the present disclosure, the piezoelectric element and the mass are configured to surround the connecting member, and a fastening lock among the mass, the piezoelectric element and the support member of the charge output device is realized by the interference fit between the piezoelectric element, and the connecting member and the mass. As a result, rigidity of the entire piezoelectric acceleration sensor can be improved, and stress fluctuations when the piezoelectric acceleration sensor is used in a high temperature environment also can be reduced, thereby measurement accuracy of the piezoelectric acceleration sensor can be improved. Further, the piezoelectric element includes a plurality of piezoelectric crystal groups, which are disposed at intervals in the circumferential direction of the connecting member and are configured to surround the connecting member in the polygonal arrangement. Therefore, the number of the piezoelectric crystals can be increased effectively, and by connecting the plurality of piezoelectric crystals in parallel, sensitivity of the charge output device and thus sensitivity of the piezoelectric acceleration sensor can be improved.

### BRIEF DESCRIPTION OF THE DRAWINGS

The drawings accompanied by the embodiments of the present disclosure will be briefly described below, and other drawings can be obtained by the person skilled in the art without any creative work.

FIG. 1 is a schematic perspective view showing a configuration of a charge output device according to an embodiment of the present disclosure;

FIG. 2 is a schematic cross-sectional view showing a configuration of a charge output device according to an embodiment of the present disclosure;

FIG. 3 is a schematic view showing a configuration of a bracket according to an embodiment of the present disclosure;

FIG. 4 is a schematic view showing a configuration of a pre-tensioning part according to an embodiment of the present disclosure;

FIG. 5 is a schematic view showing a configuration of a piezoelectric element according to an embodiment of the present disclosure;

FIG. 6 is a schematic view showing a configuration of an entire first electrode plate according to an embodiment of the present disclosure;

FIG. 7 is a schematic view showing a configuration of an entire second electrode plate according to an embodiment of the present disclosure;

FIG. 8 is a schematic view showing a configuration of an entire mass according to an embodiment of the present disclosure;

FIG. 9 is a flow chart of an assembly method S100 of a charge output device according to an embodiment of the present disclosure;

FIG. 10 is a schematic perspective view showing a configuration of a piezoelectric acceleration sensor according to an embodiment of the present disclosure; and

FIG. 11 is a schematic cross-sectional view showing a configuration of a piezoelectric acceleration sensor according to an embodiment of present disclosure.

### REFERENCE NUMERALS

1, charge output device;

10, bracket; 11, connecting member; 111, connecting part; 112, pre-tensioning assembly; 1121, pre-tensioning part; 12, support member;

20, piezoelectric element; 21, piezoelectric crystal group; 211, piezoelectric crystal; 22, electrode plate; 221, first electrode plate; 2211, first stacking portion; 2212, first connecting portion; 222, second electrode plate; 2221, second stacking portion; 2222, second connecting portion; 23 insulating plate;

30, mass;

2, base;

3, casing;

4, signal output portion; 41, pin.

### DETAILED DESCRIPTION

Below, various aspects and exemplary embodiments of the present disclosure will be described in detail. In order to clearly show the object, technical solutions and advantages of the present disclosure, the present disclosure is described in further detail below with reference to the drawings and embodiments. It should be understood that, the described embodiments are intended to explain the present disclosure, exemplarily illustrate principles of the present disclosure and are not intended to limit the scope of the present disclosure. In addition, the mechanical components in the drawings are not necessarily drawn to scale. For example, some of the mechanical components or regions in the drawings may be enlarged relative to other mechanical components or regions to facilitate an understanding of embodiments of the present disclosure.

The orientations appearing in the following description refer to directions shown in the drawings, and are not intended to limit the specific configuration of the embodiments of the present disclosure. In the description of the present disclosure, it should be noted that, unless otherwise stated, the terms “installation”, “connection”, and “coupling” are to be understood broadly, may refer to, for example, a fixed connection, a detachable connection, or an integral connection, and may refer to directly connection or indirectly connection through an intermediate medium. For the person skilled in the art, the specific meaning of the above terms in the present disclosure can be understood depending on specific situations.

Further, the terms “comprising”, “including”, “having” or any other variants are intended to cover a non-exclusive inclusion, such that the structures or components include not only those listed elements, but also include other elements that are not explicitly listed or inherently included in the structures or components. Without further limitations, an element defined by the phrase “including” does not exclude the presence of additional identical elements in the object or device including the element. The present disclosure may be implemented without some of these specific details in the present disclosure. The following description of the embodiments is merely intended to provide a better understanding of the present disclosure.

Features of various aspects and exemplary embodiments of the present disclosure are described in detail below. Further, the features, structures, or characteristics described hereinafter may be combined in any suitable manner into one or more embodiments.

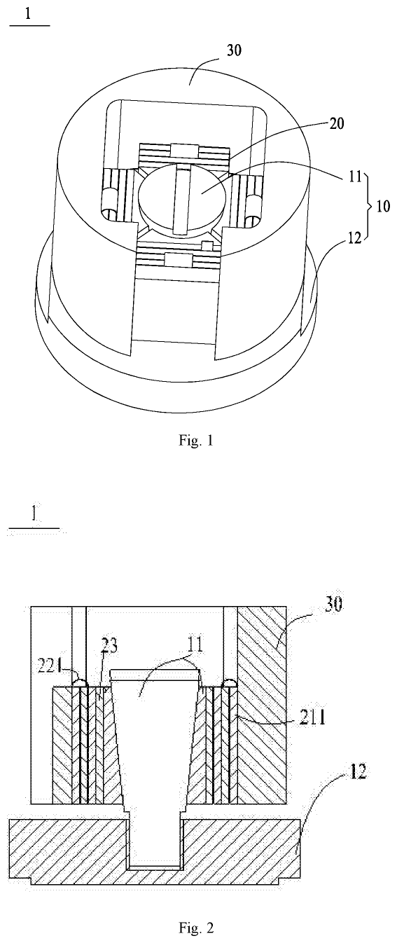

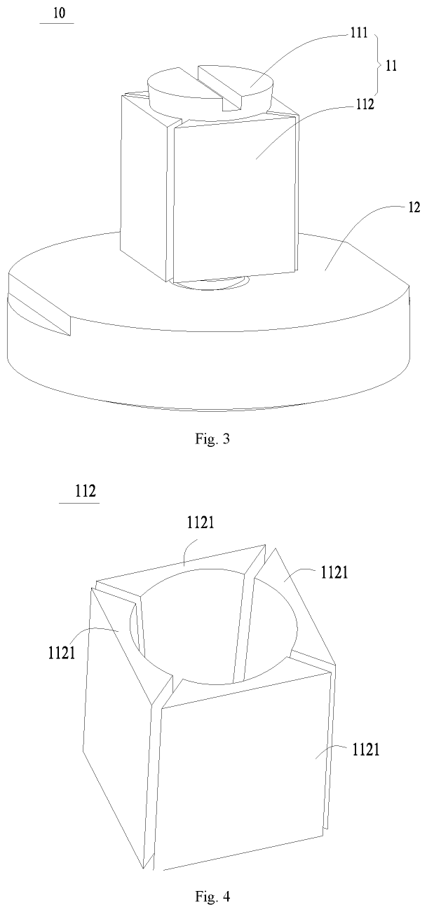

Referring to FIG. 1 and FIG. 2, FIG. 1 is a schematic perspective view showing a configuration of a charge output device according to an embodiment of the present disclosure, and FIG. 2 is a schematic cross-sectional view showing a configuration of a charge output device according to an embodiment of the present disclosure. A charge output device 1 according to the embodiment of the present disclosure includes a bracket 10, a piezoelectric element 20, and a mass 30. The bracket 10 includes a support member 12 and a connecting member 11 disposed on the support member 12. The piezoelectric element 20 is configured to surround the connecting member 11. The piezoelectric element 20 includes a plurality of piezoelectric crystal groups 21 and electrode plates 22. The plurality of piezoelectric crystal groups 21 are disposed at intervals in a circumferential direction of the connecting member 11, and are configured to surround the connecting member 11 in a polygonal arrangement. Each piezoelectric crystal group 21 includes at least one piezoelectric crystal 211, and the at least one piezoelectric crystals 211 and the electrode plates 22 are alternately stacked in a normal direction of a circumferential surface of the connecting member 11. The mass 30 is configured to surround an outer surface of the piezoelectric element 20, and is suspended above the support member 12. The piezoelectric element 20 is interference-fitted with both the connecting member 11 and the mass 30, and the respective piezoelectric crystals 211 are connected in parallel via the electrode plates 22 and the mass 30.

In the embodiment of the present disclosure, the piezoelectric element 20 and the mass 30 are configured to surround the connecting member 11, and a fastening lock among the mass 30, the piezoelectric element 20 and the support member 12 of the charge output device 1 is realized by the interference fit between the piezoelectric element 20, and the connecting member 11 and the mass 30. As a result, rigidity of the entire piezoelectric acceleration sensor can be improved, and stress fluctuations when the entire piezoelectric acceleration sensor is used in a high temperature environment also can be reduced, thereby measurement accuracy of the piezoelectric acceleration sensor can be improved. Further, the piezoelectric element 20 includes a plurality of piezoelectric crystal groups 21, which are disposed at intervals in the circumferential direction of the connecting member 11 and are configured to surround the connecting member 11 in the polygonal arrangement. Therefore, the number of the piezoelectric crystals 211 can be increased effectively, and by connecting the plurality of piezoelectric crystals 211 in parallel, sensitivity of the charge output device 1 can be improved, which can improve sensitivity of the piezoelectric acceleration sensor and also an ability of the piezoelectric acceleration sensor to resist environmental disturbances.

Specifically, the bracket 10 is made of an Inconel alloy, which can ensure that the charge output device 1 still has a linear elastic module even in a high temperature environment. As shown in FIG. 3, the support member 12 of the bracket 10 is located below the connecting member 11, and the support member 12 is formed in a shape of a disc surrounding the connecting member 11 and is located at one end of the connecting member 11. The support member 12 is provided with a mounting hole extending in an axial direction of the support member 12. The connecting member 11 is detachably connected to the support member 12 by using the mounting hole. By the detachable connection between the connecting member 11 and the support member 12, a mounting position of the connecting member 11 on the support member 12 can be adjusted, thereby improving a structural rationality of the charge output device 1. It shall be understood that the connecting member 11 may be fixedly connected to the support member 12, and it is not intended to limit the connection manner between the connecting member 11 and the support member 12 in the present disclosure.

Further, the connecting member 11 includes a connecting part 111 and a pre-tensioning assembly 112. The connecting part 111 is able to extend into the mounting hole to be connected with the bracket 10. The pre-tensioning assembly 112 is configured to surround the connecting part 111, and has a plurality of connecting faces in a circumferential direction of the connecting part 111. The plurality of piezoelectric crystal groups 21 are respectively disposed on different connecting faces. In an embodiment of the present disclosure, the connecting face of the pre-tensioning assembly 112 is formed in a planar shape, and on each connecting face, at least one piezoelectric crystal group 21 is provided. Optionally, an arrangement of the pre-tensioning assembly 112 surrounding the connecting part 111 in the circumferential direction matches the polygonal arrangement of the piezoelectric crystal groups 21, that is, one piezoelectric crystal group 21 is provided on each connecting face.

Specifically, the connecting part 111 includes a support portion and a mounting portion. The mounting portion can be connected with the support member 12. The support portion is formed in a tapered shape, and has an average radius gradually decreasing in a direction approaching the support member 12. Optionally, the connecting part 111 is a tapered self-locking bolt. One end of the tapered self-locking bolt is provided with a groove in a shape of a straight line, facilitating fastening and removing of the self-locking bolt with a tool, thereby improving assembly efficiency. The other end of the tapered self-locking bolt is threaded, and the mounting hole of the support member 12 is also threaded to match the thread on the tapered self-locking bolt, so that the connecting part 111 can be fastened to the support member 12 by a threaded connection.

Referring to FIG. 4, the pre-tensioning assembly 112 includes a plurality of pre-tensioning parts 1121. The plurality of pre-tensioning parts 1121 are disposed at intervals in the circumferential direction of the connecting part 111. The pre-tensioning assembly 112 includes a tapered through hole extending through the entire pre-tensioning assembly 112 in a thickness direction. The connecting part 111 is inserted into the tapered through hole, and an average radius of the tapered through hole gradually decreases in a direction approaching the support member 12. Optionally, the pre-tensioning assembly 112 includes four pre-tensioning parts 1121, each of which is formed as a wedge block. To improve a matching degree among the respective wedge blocks, the four wedge blocks are formed by cutting a whole quadrangular wedge block along a diagonal, and then the four wedge blocks are spliced into a quadrilateral pre-tensioning assembly 112. By forming the pre-tensioning assembly 112 with four individual pre-tensioning parts 1121, when the connecting part 111 is inserted into the tapered through hole in the pre-tensioning assembly 112, each pre-tensioning part 1121 can be moved away from the connecting part 111 in a normal direction of a circumferential surface of the connecting part 111, since the connecting part 111 mates with the pre-tensioning assembly 112 in a tapered manner and a diameter of the surface of the connecting part 111 getting into mating with the pre-tensioning assembly 112 increases gradually during the mounting of the connecting part 111. As a result, an overall offset of the pre-tensioning assembly 112 can be increased, resulting in that the piezoelectric element 20 has a larger deformation amount and can be further interference-fitted with the mass 30, thereby effectively enabling the fastening lock. Further, the pre-tensioning assembly 112 is provided with a tapered through hole in the thickness direction, which matches the connecting part 111. Thus, the tapered connecting part 111 can cooperate with the tapered through hole, so that the connecting part 111 can apply a linearly varying pressure to the piezoelectric element 20, making the piezoelectric element 20 to be less easily crushed by the wedge blocks. Alternatively, both the connecting part 111 and the pre-tensioning parts 1121 are made of an Inconel alloy, which can ensure that the charge output device still has a linear elastic module even in a high temperature environment.

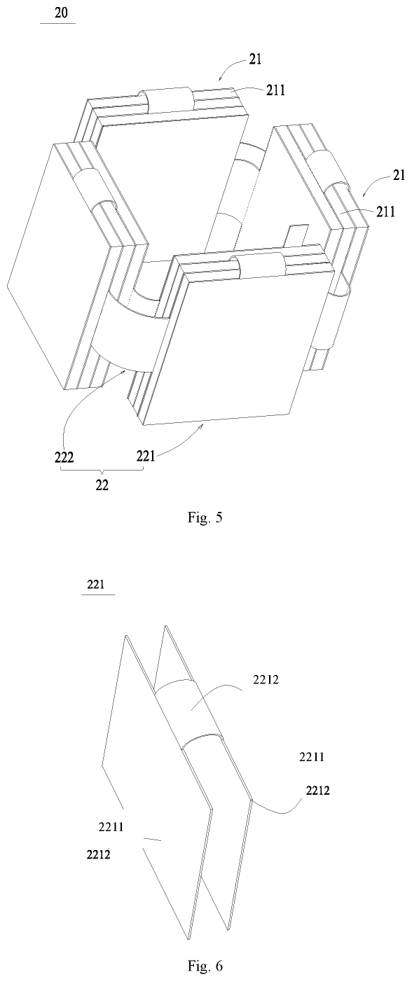

Further, in an embodiment of the present disclosure, the plurality of piezoelectric crystal groups 21 are arranged in a quadrangular shape surrounding the connecting member 11, that is, the piezoelectric element 20 includes four piezoelectric crystal groups 21, and an insulating plate 23 is disposed between each piezoelectric crystal group 21 and the connecting member 11. Referring to FIG. 5, each piezoelectric crystal group 21 includes three piezoelectric crystals 211, and each piezoelectric crystal 211 is formed in a shape of plate. The piezoelectric crystal 211 is made of ceramic. Each piezoelectric crystal 211 has conductive layers at both ends in a thickness direction. The respective conductive layers of the respective piezoelectric crystals 211 are connected via the electrode plates 22 to realize parallel connection of the piezoelectric element 20, and the respective piezoelectric crystal groups 21 are insulated from the support member 12 of the bracket 10 by the insulating plates 23. In this case, the piezoelectric element 20 has twelve piezoelectric crystals 211, and thus has a remarkably improved sensitivity compared to a piezoelectric element provided with a single piezoelectric crystal 211 and can detect the acceleration more accurately. The four piezoelectric crystal groups 21 are disposed at intervals, resulting in that the piezoelectric element 20 has a larger deformation amount, and the interference fit can be realized more effectively. It can be understood that the piezoelectric element 20 may have five, six or three piezoelectric crystal groups 21, and the number of the piezoelectric crystals 211 in the piezoelectric crystal group 21 can be selected according to the actual requirements of sensitivity, and is not limited in the present disclosure.

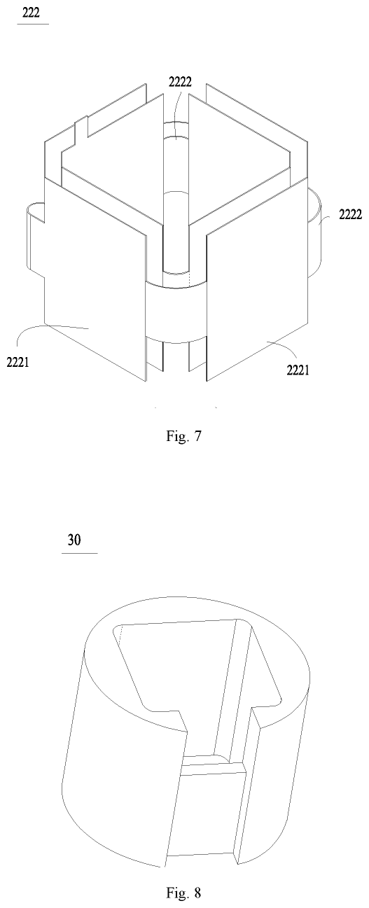

Referring to FIG. 6 and FIG. 7, the electrode plates include a plurality of first electrode plates 221 and at least one second electrode plate 222. One of positive electrodes and negative electrodes of the respective piezoelectric crystals 211 are connected via the first electrode plates 221 and the mass 30, and the other one of the positive electrodes and the negative electrodes of the respective piezoelectric crystals 211 are connected via the second electrode plate 222. Two surfaces of two adjacent piezoelectric crystals 211 close to each other in the piezoelectric crystal group 21 have the same polarity, which is convenient for disposing one electrode plate between adjacent two piezoelectric crystals 211 and leading an electrode out through the electrode plate. Alternatively, the plurality of piezoelectric crystals 211 are connected in parallel by the electrode plates, wherein the negative electrodes of all the piezoelectric crystals 211 are connected and lead out by the second electrode plates 222, and all the positive electrodes of all the piezoelectric crystals 211 are connected to the mass 30 and lead out by the first electrode plates 221. By changing the number of piezoelectric crystals 211, the sensitivity can be increased or decreased.

According to an aspect of the present disclosure, the piezoelectric crystal group 21 includes a plurality of piezoelectric crystals 211, the first electrode plate 221 includes a first stacking portion 2211 and a first connecting portion 2212, and the first stacking portion 2211 is disposed between two adjacent piezoelectric crystals 211 in the piezoelectric crystal group 21. The second electrode plate 222 includes a second stacking portion 2221 and a second connecting portion 2222, and the second stacking portion 2221 is disposed between two adjacent piezoelectric crystals 211 in the piezoelectric crystal group 21, wherein the first stacking portion 2211 and the second stacking portion 2221 are alternately disposed, and only the first stacking portion 2211 or only the second stacking portion 2221 is disposed between two adjacent piezoelectric crystals 211. The first connecting portion 2212 is connected to the first stacking portion 2211, and the second connecting portion 2222 is connected to the second stacking portion 2221. The first stacking portion 2211 has a size greater than or equal to that of the piezoelectric crystal 211, so that the piezoelectric crystal 211 can be entirely attached to the first electrode plate 221; and/or the second stacking portion 2221 has a size greater than or equal to that of the piezoelectric crystal 211, so that the piezoelectric crystal 211 can be entirely attached to the second electrode plate 222.

According to an aspect of the present disclosure, the first electrode plate 221 includes two or more first stacking portions 2211 and at least one first connecting portion 2212, and the first stacking portion 2211 is further disposed between the piezoelectric crystal 211 of an outermost layer and the mass 30. The first connecting portion 2212 is connected to two or more first stacking portions 2211, which are included in the same piezoelectric crystal group 21. That is, the first electrode plate 221 is merely used to connect the piezoelectric crystals 211 in the piezoelectric crystal group 21 in parallel, and the piezoelectric crystals 211 in different piezoelectric crystal groups 21 are connected by the mass 30; and/or, the second electrode plate 222 is disposed surrounding the piezoelectric element 20 in the circumferential direction thereof and includes a plurality of second stacking portions 2221 and a plurality of second connection portions 2222, and the second stacking portions 2221 of the same layer in the respective piezoelectric crystal groups 21 are connected by the second connecting portion 2222 to form a broken annular structure in a circumferential direction.

Adjacent two annular structures are connected by the second connecting portion 2222 (although the connection is not shown in the drawings). The negative electrodes of the plurality of piezoelectric crystals 211 can be lead out by the second electrode plate 222. Optionally, one of the second stacking portions 2221 is provided with a protrusion, which is adapted to connect with a negative electrode of a connector of the piezoelectric acceleration sensor.

Specifically, the first connecting portion 2212 of the first electrode plate 221 is disposed above the piezoelectric crystal group 21, while the second connecting portion 2222 of the second electrode plate 222 is disposed in the circumferential direction of the piezoelectric crystal group 21. Thus, space can be rationally utilized, intersection of the first electrode plate 221 and the second electrode plate 222 can be prevented, and it is also convenient for later maintenance and inspection.

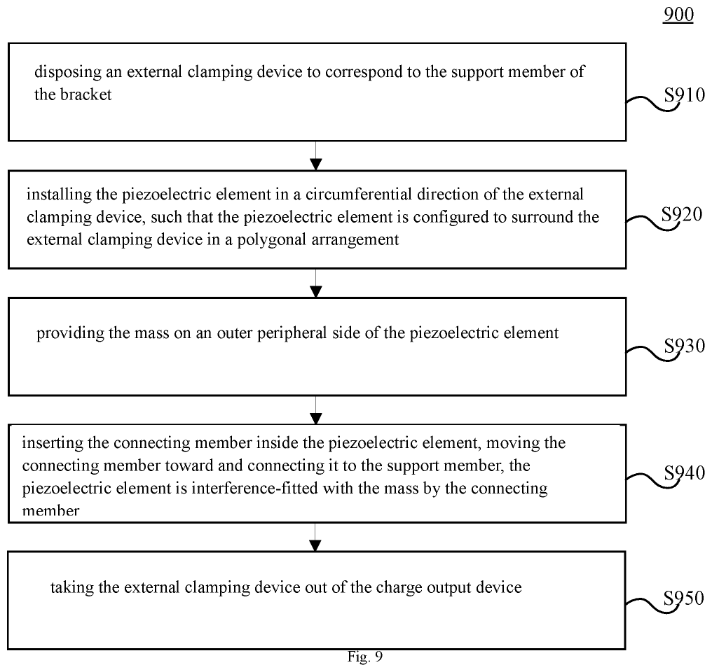

Referring to FIG. 8, the mass 30 according to the embodiment of the present disclosure is configured to surround the piezoelectric element 20 and is provided with a polygonal through hole in a thickness direction thereof. The polygonal through hole is configured to correspond to the piezoelectric crystal group 21, so that the piezoelectric crystal 211 can be better attached to an inner surface of the mass 30. In the embodiment of the present disclosure, the positive electrodes of the piezoelectric crystals 211 in the piezoelectric crystal group 21 are connected by the first electrode plate 221; a first stacking portion 2211 is disposed between the piezoelectric crystal 211 of the outermost layer and the mass 30, and the piezoelectric crystals 211 in the four piezoelectric crystal groups 21 are connected in parallel by the mass 30. Thus, the positive electrodes of the piezoelectric crystals 211 can be connected by the first electrode plate 221 together with the mass 30. The piezoelectric element 20 in the charge output device 1 is interference-fitted with the mass 30 and the connecting member 11 of the bracket 10, and no connection layer or glue connection is required. That is, the piezoelectric element 20, the mass 30 and the bracket 10 contact with each other rigidly, which can improve stiffness and reliability of the entire charge output device 1, thereby increasing frequency response characteristics and resonance of the piezoelectric acceleration sensor. Meanwhile, since the piezoelectric crystals 211 are stacked on four faces simultaneously, the sensor can have a high sensitivity to mass ratio. Compared to the conventional configuration, higher sensitivity can be obtained with a mass 30 of the same weight.

Another aspect of the present disclosure provides an assembly method 900 of the charge output device 1. Referring to FIG. 9, the assembly method includes the following steps.

In S910, disposing an external clamping device to correspond to the support member of the bracket.

In this step, by disposing the external clamping device correspondingly to the support member 12, that is, fixing a position of the external clamping device relative to the support member 12, it is able to provide a more stable and accurate platform for the assembly of the charge output device 1, and provide position limits for the subsequent components to be assembled.

In S920, installing the piezoelectric element in a circumferential direction of the external clamping device, such that the piezoelectric element is configured to surround the external clamping device in a polygonal arrangement.

In this step, the external clamping device has limit structures on four sides and also has an axial limit structure, and four piezoelectric crystal groups 21 of the piezoelectric element 20 are respectively installed on the four sides of the external clamping device, and the position of the piezoelectric element 20 is also limited in an axial direction by the limited structure. In this state, the piezoelectric element 20 forms a quadrangular through hole extending through the entire piezoelectric element 20 in the thickness direction.

In S930, providing the mass on an outer peripheral side of the piezoelectric element.

In this step, the mass 30 is placed above the support member 12 and is suspended.

In S940, inserting the connecting member inside the piezoelectric element, moving the connecting member toward and connecting it to the support member, wherein the piezoelectric element is interference-fitted with the mass by the connecting member.

In this step, the pre-tensioning part 1121 is installed to each face of the quadrangular through hole of the piezoelectric element 20. During the installation, the connecting face of the pre-tensioning part 1121 is attached to one of the planes of the piezoelectric element 20, so that the pre-tensioning assembly 112 forms the tapered through hole; then, the connecting part 111 is inserted into the tapered through hole and connected to the support member 12. A mounting tool, such as a torque wrench is used to adjust the connecting part 111 and control a locking torque of the connecting part 111 to perform the locking.

In S950, taking out of the external clamping device from the charge output device.

In the assembly method of the charge output device 1 according to the embodiment of the present disclosure, by disposing the external clamping device at a corresponding position above the support member 12, the position of the piezoelectric element 20 is limited in the axial direction, and meanwhile, while connecting the connecting part 111 to the support member 12, the piezoelectric element 20 is tightly pressed against the inner surface of the mass 30 by the connecting part 111. During the above process, the assembly of the charge output device 1 can be completed without any other connection layer. During assembly, a good preloading effect can be achieved merely by using the torque wrench to control the locking torque of the connecting part. With such a configuration, the piezoelectric crystal 211 is allowed to be sheared and output electric charges, when the sensor is subjected to an alternating force perpendicular to the base 2. Since interference fit is employed among the mass 30, the piezoelectric element 20, and the bracket 10, the rigidity of the entire charge output device 1 can be increased, and thus the frequency response characteristics and resonance of the piezoelectric acceleration sensor can be improved. Moreover, by providing the piezoelectric crystals 211 connected in parallel on a plurality of faces, the detection sensitivity of the charge output device 1 can be effectively improved. After the piezoelectric material is assembled, the bolt and the base 2 are welded to damage the thread pair for reliability and loosing prevention.

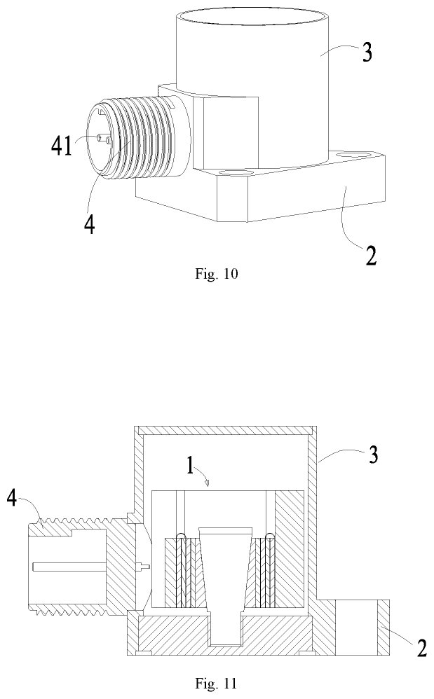

Another aspect of the present disclosure provides a piezoelectric acceleration sensor, which includes the above-described charge output device 1, a casing 3 having an accommodation space, and a connector disposed on the casing 3, wherein the above-described charge output device is disposed in the accommodation space. By referring to FIG. 10 and FIG. 11 together, FIG. 10 is a schematic perspective view showing a configuration of a piezoelectric acceleration sensor according to an embodiment of the present disclosure, and FIG. 11 is a schematic cross-sectional view showing a configuration of a piezoelectric acceleration sensor according to an embodiment of the present disclosure. The piezoelectric acceleration sensor of this embodiment further includes a signal output portion 4. The charge output device 1 can be sealed in the casing 3 and protected by the casing 3. The casing 3 further includes a base 2. The base 2 is formed in a triangular shape, which can reduce occupied space thereof. Meanwhile, the base 2 is provided with a mounting portion, by which the piezoelectric acceleration sensor can be installed to a device under test. A pin 41 of the signal output portion 4 is electrically connected to the mass 30 and the piezoelectric components. Specifically, the signal output portion 4 can be electrically connected to the mass 30 and the piezoelectric components via two signal transmission lines. One of the two signal transmission lines has one end connected to the mass 30 or the first electrode plate 221 and the other end connected to the signal output portion 4, and the other signal transmission line has one end connected to the second electrode plate 222 and the other end connected to the signal output portion 4. As such, the signal of the charge output device 1 can be transmitted to an external device through the signal output portion 4. The casing of the piezoelectric acceleration sensor of the present embodiment is made of the Inconel alloy, so that the casing can still maintain a good line shape and rigidity at a high temperature, thereby ensuring a small change in the frequency response of the sensor in a high temperature environment.

It shall be understood that the terms “first”, “second”, and the like are used to distinguish one entity or operation from another entity or operation, without necessarily requiring or implying any actual relationships or sequences between these entities or operations. It shall be understood that such terms are interchangeable, when appropriate, such that the embodiments of the present disclosure described herein, for example, can operate or arrange in sequence besides the sequences described in the present disclosure or stated otherwise.

The present disclosure may be embodied in other specific forms without departing from the spirit and essential characteristics. The present embodiments are to be considered in all respects as illustrative and not restrictive. The scope of the present disclosure is defined by the attached claims while not the above description, and all variations that fall within the scope of the meaning of the claims and equivalents thereof are thus included in the scope of the present disclosure. Moreover, different technical features that appear in different embodiments can be combined to achieve a beneficial effect. Other variations of the disclosed embodiments can be understood and implemented by the person skilled in the art, based on studying the drawings, specification and the claims.

What is claimed is:

1. A charge output device, comprising:
a bracket, comprising a support member and a connecting member disposed on the support member;
a piezoelectric element, configured to surround the connecting member, the piezoelectric element comprises a plurality of piezoelectric crystal groups and electrode plates, wherein the plurality of the piezoelectric crystal groups are disposed at intervals in a circumferential direction of the connecting member and are configured to surround the connecting member in a polygonal arrangement, the piezoelectric crystal group comprises at least one piezoelectric crystal, and the at least one piezoelectric crystal and the electrode plates are alternately stacked in a normal direction of a circumferential surface of the connecting member; and
a mass, configured to surround an outer surface of the piezoelectric element and suspended above the support member,
wherein the connecting member, the piezoelectric element and the mass are interference-fitted with each other, and the respective piezoelectric crystals are connected in parallel via the electrode plates and the mass.

2. The charge output device of claim 1, wherein the electrode plates comprise a plurality of first electrode plates and at least one second electrode plate, one of positive electrodes and negative electrodes of the respective piezoelectric crystals are connected via the first electrode plates and the mass, and the other one of the positive electrodes and the negative electrodes of the respective piezoelectric crystals are connected via the at least one second electrode plate; and
wherein two surfaces of two adjacent piezoelectric crystals in the piezoelectric crystal group, close to each other, have the same polarity.

3. The charge output device of claim 2, wherein the piezoelectric crystal group comprises a plurality of piezoelectric crystals, and the first electrode plate comprises a first stacking portion and a first connecting portion, the first stacking portion is disposed between two adjacent piezoelectric crystals in the piezoelectric crystal group; and the second electrode plate comprises a second stacking portion and a second connecting portion, the second stacking portion is disposed between two adjacent piezoelectric crystals in the piezoelectric crystal group, the first stacking portion and the second stacking portion are alternately disposed, the first connecting portion is connected with the first stacking portion, and the second connecting portion is connected with the second stacking portion; and
at least one of the first stacking portion and the second stacking portion has a size greater than or equal to that of the piezoelectric crystal, such that the piezoelectric crystal is entirely attached to the first electrode plate and/or the second electrode plate.

4. The charge output device of claim 3, wherein the first electrode plate comprises a plurality of the first stacking portions and at least one first connecting portion, the first stacking portion is further disposed between the piezoelectric crystal of an outermost layer and the mass, and the first connecting portion is configured to connect two or more of the first stacking portions in the piezoelectric crystal group.

5. The charge output device of claim 3, wherein the second electrode plate comprises a plurality of the second stacking portions and a plurality of the second connecting portions, the second electrode plate is disposed to surround the piezoelectric element in a circumferential direction of the piezoelectric element, the respective second stacking portions of the same layer in the respective piezoelectric crystal groups are connected by the second connecting portions to form a broken annular structure in the circumferential direction, and two adjacent annular structures are connected by the second connecting portion.

6. The charge output device of claim 4, wherein the second electrode plate comprises a plurality of the second stacking portions and a plurality of the second connecting portions, the second electrode plate is disposed to surround the piezoelectric element in a circumferential direction of the piezoelectric element, the respective second stacking portions of the same layer in the respective piezoelectric crystal groups are connected by the second connecting portions to form a broken annular structure in the circumferential direction, and two adjacent annular structures are connected by the second connecting portion.

7. The charge output device of claim 1, wherein the support member comprises a mounting hole extending in an axial direction of the support member;
the connecting member comprises a connecting part and a pre-tensioning assembly, the connecting part is able to extend into the mounting hole to be connected with the bracket, and the pre-tensioning assembly is configured to surround the connecting part and has a plurality of connecting faces distributed in a circumferential direction of the pre-tensioning assembly; and
the plurality of the piezoelectric crystal groups are respectively disposed on different connecting faces.

8. The charge output device of claim 7, wherein the connecting part comprises a support portion and a mounting portion, the mounting portion is connectable with the support member, and the support portion is formed in a tapered shape and has an average radius gradually decreasing in a direction approaching the support member.

9. The charge output device of claim 7, wherein the connecting part is a tapered self-locking bolt.

10. The charge output device of claim 7, wherein the pre-tensioning assembly comprises a plurality of pre-tensioning parts, and the plurality of pre-tensioning parts are disposed at intervals in the circumferential direction of the connecting part; and
the pre-tensioning assembly is provided with a tapered through hole extending through the entire pre-tensioning assembly in a thickness direction, the connecting part is inserted into the tapered through hole, and an average radius of the tapered through hole gradually decreases in a direction approaching the support member.

11. An assembly method of the charge output device according to claim 1, comprising steps of:
disposing an external clamping device to correspond to the support member of the bracket;
installing the piezoelectric element in a circumferential direction of the external clamping device, such that the piezoelectric element is configured to surround the external clamping device in a polygonal arrangement;
providing the mass on an outer peripheral side of the piezoelectric element;
inserting the connecting member inside the piezoelectric element, moving the connecting member toward and connecting it to the support member, wherein the piezoelectric element is interference-fitted with the mass by the connecting member; and
taking the external clamping device out of the charge output device.

12. A piezoelectric acceleration sensor, comprising:
the charge output device according to claim 1;
a casing having an accommodation space, wherein the charge output device is disposed in the accommodation space; and
a signal output portion disposed on the casing.

13. The piezoelectric acceleration sensor of claim 12, wherein the electrode plates comprise a plurality of first electrode plates and at least one second electrode plate, one of positive electrodes and negative electrodes of the respective piezoelectric crystals are connected via the first electrode plates and the mass, and the other one of the positive electrodes and the negative electrodes of the respective piezoelectric crystals are connected via the at least one second electrode plate; and
wherein two surfaces of two adjacent piezoelectric crystals in the piezoelectric crystal group, close to each other, have the same polarity.

14. The piezoelectric acceleration sensor of claim 13, wherein the piezoelectric crystal group comprises a plurality of piezoelectric crystals, and the first electrode plate comprises a first stacking portion and a first connecting portion, the first stacking portion is disposed between two adjacent piezoelectric crystals in the piezoelectric crystal group; and the second electrode plate comprises a second stacking portion and a second connecting portion, the second stacking portion is disposed between two adjacent piezoelectric crystals in the piezoelectric crystal group, the first stacking portion and the second stacking portion are alternately disposed, the first connecting portion is connected with the first stacking portion, and the second connecting portion is connected with the second stacking portion; and
at least one of the first stacking portion and the second stacking portion has a size greater than or equal to that of the piezoelectric crystal, such that the piezoelectric crystal is entirely attached to the first electrode plate and/or the second electrode plate.

15. The piezoelectric acceleration sensor of claim 14, wherein the first electrode plate comprises a plurality of the first stacking portions and at least one first connecting portion, the first stacking portion is further disposed between the piezoelectric crystal of an outermost layer and the mass, and the first connecting portion is configured to connect two or more of the first stacking portions in the piezoelectric crystal group.

16. The piezoelectric acceleration sensor of claim 14, wherein the second electrode plate comprises a plurality of the second stacking portions and a plurality of the second connecting portions, the second electrode plate is disposed to surround the piezoelectric element in a circumferential direction of the piezoelectric element, the respective second stacking portions of the same layer in the respective piezoelectric crystal groups are connected by the second connecting portions to form a broken annular structure in the circumferential direction, and two adjacent annular structures are connected by the second connecting portion.

17. The piezoelectric acceleration sensor of claim 15, wherein the second electrode plate comprises a plurality of the second stacking portions and a plurality of the second connecting portions, the second electrode plate is disposed to surround the piezoelectric element in a circumferential direction of the piezoelectric element, the respective second stacking portions of the same layer in the respective piezoelectric crystal groups are connected by the second connecting portions to form a broken annular structure in the circumferential direction, and two adjacent annular structures are connected by the second connecting portion.

18. The piezoelectric acceleration sensor of claim 12, wherein the support member comprises a mounting hole extending in an axial direction of the support member;
the connecting member comprises a connecting part and a pre-tensioning assembly, the connecting part is able to extend into the mounting hole to be connected with the bracket, and the pre-tensioning assembly is configured to surround the connecting part and has a plurality of connecting faces distributed in a circumferential direction of the pre-tensioning assembly; and
the plurality of the piezoelectric crystal groups are respectively disposed on different connecting faces.

19. The piezoelectric acceleration sensor of claim 18, wherein the connecting part comprises a support portion and a mounting portion, the mounting portion is connectable with the support member, and the support portion is formed in a tapered shape and has an average radius gradually decreasing in a direction approaching the support member.

20. The charge output device of claim 18, wherein the connecting part is a tapered self-locking bolt.
